(19) United States
(12) Patent Application Publication
(10) Pub. No.: US 2010/0148513 A1
(43) Pub. Date: Jun. 17, 2010

(54) POWER GENERATOR AND TURBINE UNIT

(76) Inventors: Hector Filippus Alexander Van Drentham Susman, Aberdeen (GB); Kenneth Roderick Stewart, Aberdeen (GB); Donald Stewart, Aberdeen (GB)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/530,984

(22) PCT Filed: Mar. 13, 2008
(86) PCT No.: PCT/GB08/00889

§ 371 Date: Jan. 27, 2010

(30) Foreign Application Priority Data
Mar. 14, 2007 (GB) 0704897.8
May 22, 2007 (GB) 0709802.3

(51) Int. Cl. F03B 13/10

(52) U.S. Cl. 290/54

(57) ABSTRACT

Underwater power generator or turbine unit (2; 102; 202; 302; 402) comprises a first housing part (4; 104; 204; 304P, a second body part (6; 106, 206, 306, 406) and means for connecting the first and second housing parts (4, 6; 104, 106; 204, 206; 304, 306; 404; 406). The connecting means (8; 108; 208; 308) comprise a plurality of bars (22; 122; 222; 322). The generator (2; 102; 202; 302) comprises a base (28; 128; 228; 328), having three logs (30, 32, 130, 132, 134; 230, 232,234;330, 332, 334; 430, 432, 434). The generator (2; 102; 202; 302, 402) and flow channel (44; 104; 204, 304) having first and second ends, the legs (30, 32,34; 130, 132, 134; 230, 232, 234, -330, 332, 334; 430, 432, 434) having provided longitudinally outwardly of the ends and/or transversely outwardly of sides of the flow channel (44; 104; 204; 304).

### FIELD OF INVENTION

The present invention relates to a power generator and to a turbine unit. In particular, but not exclusively, the present invention relates to an electrical power generator, for example, comprising an underwater turbine unit, and to an underwater turbine unit.

The invention also relates to an underwater power generator, e.g. powered by tidal stream or underwater currents, and to a power generation farm using at least one or a plurality of such generators.

### BACKGROUND TO INVENTION

To meet increasing energy needs, there is a general desire to develop environmentally friendly methods of generating electrical power. One particular area of interest involves the generation of power using tidal energy. This may be achieved by using underwater turbines.

Problems associated with known underwater turbines include the need to carefully seal generator assemblies provided as part of the turbine to prevent the ingress of water, and also maintenance difficulties. This is because the complete turbine must be recovered to allow maintenance to any turbine part. There have also been difficulties in optimising electrical power generation.

The content of WO 03/029645 A1 (ROTECH HOLDINGS LIMITED) and of WO 2006/125959 A1 (ROTECH HOLDINGS LIMITED) are incorporated herein by reference.

A number of problems have been identified in the prior art.

One problem relates to the facilitation of initial positioning of the turbine unit part within the underwater turbine unit, e.g. when on land, such as in a fabrication yard or dock, when above surface, such as a vessel or when underwater.

Another problem relates to facilitation of removal of the turbine unit part from and/or replacement of the turbine unit part within the underwater turbine unit, e.g. when underwater.

Another problem relates to positioning of the underwater turbine unit underwater on a seabed, ocean floor or river bed in a stable position, and/or desired orientation.

Another problem relates to the stability of the turbine unit when on the sea bed, ocean floor or river bed.

Another problem relates to sealing between the turbine unit part and the housing.

Another problem to be addressed is the provision of a renewable and predictable power generator.

It is an object of at least one embodiment of at least one aspect of the present invention to obviate or at least mitigate one or more problems in the prior art.

It is a further object of one or more embodiments of at least one aspect of the present invention to provide an underwater turbine unit, which, in use, is driven by tidal and/or current flow, and which can preferably operate in ebb and/or flood tides without a need for movement or realignment into a tidal flow direction.

It is a yet further object of at least one embodiment of at least one aspect of the present invention to provide a power generator apparatus or farm, which is substantially or wholly underwater, thereby minimising environmental impact.

It is a still further object of at least one embodiment of at least one aspect of the present invention to provide a power generator apparatus wherein maintenance may be carried out without diver or ROV (Remotely Operated Vehicle) intervention.

### SUMMARY OF INVENTION

According to a first aspect of the present invention there is provided an underwater power generator or turbine unit comprising a first housing part, a second housing part and means for connecting and/or spacing the first and second housing parts together.

The connecting means may bridge a gap or space between the first and second housing parts.

The first housing part may comprise an at least partly frusto-conical inner surface and/or may comprise an at least partly frusto-conical outer surface.

The second housing part may comprise an at least partly frusto-conical inner surface and/or may comprise an at least partly frusto-conical outer surface.

Ends, for example narrower ends, of the first and second housing parts may be proximally spaced.

The connecting means may control or select a spacing between the first and second housing parts.

The connecting means may comprise one or preferably a plurality of elongate members or bars.

One end of the/each bar may be attached/attachable, e.g. detachably attached/attachable, to the first housing part, and another end of the/each bar may be attached/attachable, e.g. detachably attached/attachable, to the second housing part.

For example, the ends may be flanged. The ends may be welded, bolted or otherwise fixed to the respective housing part, e.g. on an outer surface thereof.

The bars may be provided around lower circumferential surfaces of the housing parts.

The bars may be circumferentially spaced from one another.

The underwater power generator or turbine unit may also comprise a module, e.g. a turbine module, which may be receivably removable within the gap or space between the first and second housing parts.

According to a second aspect of the present invention there is provided an underwater power generator or turbine unit comprising a base, wherein the base comprises three legs.

Most preferably, there are provided only three legs.

This provides a particularly stable arrangement.

Most preferably, there are provided only three legs. This provides a particularly stable arrangement.

There may be provided a pair of legs at one end, and a third leg at another end.

The first and second legs may be symmetrically disposed on respective sides of a longitudinal axis of the power generator.

The third leg may be aligned with or provided upon the longitudinal axis.

The legs may be hollow.

The legs may include ballast.

A volume of the first and second legs may be substantially the same.

A volume of the third leg may be greater than, e.g. substantially double, the volume of either of the first or second legs.

Preferably a bar or member (torsion bar) is provided longitudinally extending from the third leg to between the first and second legs.

Preferably a further bar is provided (transversely) between the first and second legs, an end of the bar being connected thereto.

First and second symmetrically disposed yet further bars may be provided between the bar and the further bar.

According to a third aspect of the present invention there is provided an underwater power generator or turbine unit comprising a flow channel having first and second ends and a plurality of legs, wherein the legs are provided longitudinally outwardly of the ends of flow channel and/or transversely outwardly of sides of the flow channel.

This facilitates ease of lifting of the generator by means of the legs.

In a preferred arrangement there are provided a pair of legs outwardly of one end and a third leg outwardly of the other end. The pair of legs may also be provided outwardly of respective sides of the housing.

According to a fourth aspect of the present invention there is provided an underwater power generator or turbine unit comprising a housing and a turbine module, wherein the turbine module is removably receivable relative to or within the housing, and wherein there are provided sealing means between the housing and the turbine module.

The housing may comprise first and second housing parts.

The turbine module may be locatable between the first and second housing parts.

The sealing means may comprise a polymeric material.

The sealing means may comprise first sealing means provided between a first end of the module and the first housing part.

The sealing means may comprise second sealing means provided between a second end of the module and the second housing part.

The first sealing means may be provided on a lower face of a flange provided around at least part of an upper circumferential part of the first end of the module.

The first sealing means additionally or alternatively may be provided on a lower face of another flange provided around at least part of a lower circumferential part of the first end of the module.

The second sealing means may be the same as or similar to the first sealing means but provided on the second end of the module. In other words, the second sealing means may be provided on a lower face of a flange provided around at least part of an upper circumferential part of the second end of the module. The second sealing means additionally or alternatively may be provided on a lower face of another flange provided around at least part of a lower circumferential part of the first end of the module.

According to a fifth aspect of the present invention there is provided an underwater power generator or turbine unit comprising at least one ground engaging leg, wherein the ground engaging leg comprises a ground engaging means or peripherally extending skirt.

The ground engaging means or peripherally extending skirt may assist in the at least one leg digging into the ground, e.g. seabed, ocean floor or river bed.

Where the ground engaging means comprises a peripherally extending skirt, the skirt may be continuous, e.g. forming a closed shape or discontinuous.

At least one and preferably each leg comprises a hollow tube, which may be disposed substantially vertically, in use.

It will be appreciated that any of the features of any of the foregoing aspects may be combined one with the other singly or in combination.

The following further features may apply to any of the foregoing aspects:

The power generator may comprise at least one underwater turbine unit providing a housing having a flow channel therethrough and at least one turbine means mounted in the flow channel for rotation in response to water flow through the flow channel, wherein the turbine unit provides a turbine unit part or turbine module releasably mountable in the turbine unit, the turbine unit part including at least one of the at least one turbine means and a pump means.

The turbine unit part may be releasably mountable through an aperture or gap in a side or side wall of the housing.

The power generator may comprise at least one underwater turbine unit including a housing having a liquid flow channel therethrough and at least one turbine means mounted in the flow channel for rotation in response to liquid flow through the flow channel.

The power generator may comprise at least one underwater turbine unit providing a housing and at least one turbine means,

the housing having a liquid flow channel extending therethrough between first and second ends of the housing, the flow channel defining a flow restriction comprising a venturi, and

the at least one turbine means being mounted in the flow channel for rotation along an axis parallel to the flow channel, wherein, in use, the housing is stationary and the turbine rotates in response to liquid flow through the flow channel, and wherein

the housing is provided with a waist on an outermost surface thereof, the waist being narrower than the first and second ends of the housing.

The underwater turbine unit may comprise at least one turbine, the turbine comprising at least one blade, the at least one blade comprising at least one aerofoil which is symmetrical about a mid-chord line thereof.

According to a sixth aspect of the present invention there is provided a docking device for installing and/or removing a turbine module or cassette from a housing or remainder of an underwater power generator or turbine unit.

The docking device may have means for releasably connecting the docking device to the turbine module.

The docking device may have means for positioning the docking device relative to the housing.

The docking device may comprise a hydraulic latch for retaining the turbine module.

The docking device may comprise at least one and preferably two transversely symmetrically disposed male or female portions matable with a respective at least one or preferably two transversely symmetrically disposed female or male portions on the housing.

According to a seventh aspect of the present invention there is provided an underwater housing having at least one and preferably two transversely symmetrically disposed female or male portions matable with a docking device having a corresponding at least one and preferably two transversely symmetrically disposed male or female portions.

According to an eighth aspect of the present invention there is provided an underwater power generator or turbine unit comprising a housing according to the seventh aspect of the present invention.

According to a ninth aspect of the present invention there is provided a method of assembling an underwater power generator comprising:
(a) providing first and second spaced housing parts;
(b) providing a connection means for the first and second housing parts;
(c) locating a turbine module between the housing parts;
(d) longitudinally moving one or both of the housing parts and/or turbine module to (suitably) locate the housing parts and turbine module relative to one another; and
(e) securing the connection means.

Preferably step (e) is carried out after step (d).

Alternatively step (e) is carried out before step (d).

Suitable location allows for removal of the module from the housing parts and optionally and preferably relocation of the module between the housing parts, either on-shore or in situ underwater. Removal and/or relocation may be effected by a substantially vertical raising or lowering movement of the turbine module.

Suitable location also allows for sealing means between the module and the first and/or second housing parts to seal.

The module may provide an annular member, which, optionally with the housing parts, form a housing or cowal for a turbine of or in the module. The housing may comprise a through flow channel within which the turbine is located for rotation around a longitudinal axis of the channel.

In a modification the method may comprise:

providing a base, either underwater or on shore;

installing an assembly comprising the housing parts and turbine module onto the base.

The base and assembly may have co-acting (releasable) connection means, e.g. fore and aft female and male connections.

Any of the underwater power generators according to any of the aspects of the present invention may comprise electricity power generators.

The underwater power generator according to any of the aspects of the present invention may be capable of operation in one of two flow, e.g. tidal flow, directions, e.g. ebb and flood.

The power generator may comprise a flow channel, which may comprise a venturi, e.g. a convergent-divergent venturi.

The turbine may be provided at a mid-point or narrow portion of the flow channel.

The housing may comprise a waist portion on an external surface thereof—this may assist fluid flow through and/or around the housing.

The sealing means may be collapsible, crushable and/or hollow.

### BRIEF DESCRIPTION OF DRAWINGS

Embodiments of the invention will now be described by way of example only, and with reference to the accompanying drawings, which are:

FIG. 1 a schematic side view of a power generator according to a first embodiment of the present invention;

FIG. 2 a schematic top view of a support base or tripod comprising part of the power generator of FIG. 1;

FIG. 3 a schematic end view of the power generator of FIG. 1;

FIG. 4 a top view of a turbine module or cassette of the power generator of FIG. 1;

FIG. 5 a top view of a housing and turbine module of a power generator of FIG. 1;

FIG. 6 a side view of the turbine module of FIG. 4;

FIG. 7 a side view of the turbine module attached to a docking device or aid;

FIG. 8 a front view of the turbine module attached to the docking aid of FIG. 7;

FIG. 9 a front cross-sectional view of part of the housing of the power generator of FIG. 1;

FIG. 10 a front view of the turbine module of FIG. 4;

FIG. 11 a partially cutaway perspective view from one end of a power generator according to a second embodiment of the present invention;

FIG. 12 a perspective view from one end of a power generator according to a third embodiment of the present invention;

FIG. 13 a plurality of the power generators of FIG. 12 operatively connected to form a tidal stream power farm;

FIG. 14 a schematic side view of a power generator according to a fourth embodiment of the present invention with a turbine module or cassette thereof removed;

FIG. 15 a schematic end view of the power generator of FIG. 14;

FIG. 16 a cross-sectional side view of a turbine module or cassette of the power generator of FIG. 14 attached to a docking device or aid;

FIG. 17 an end view of the turbine module of FIG. 16 attached to the docking aid;

FIG. 18 an exploded side cross-sectional view of part of the power generator of FIG. 14; and

FIGS. 19(a) and (b) side and end views of a power generator according to a fifth embodiment of the present invention.

### DETAILED DESCRIPTION OF DRAWINGS

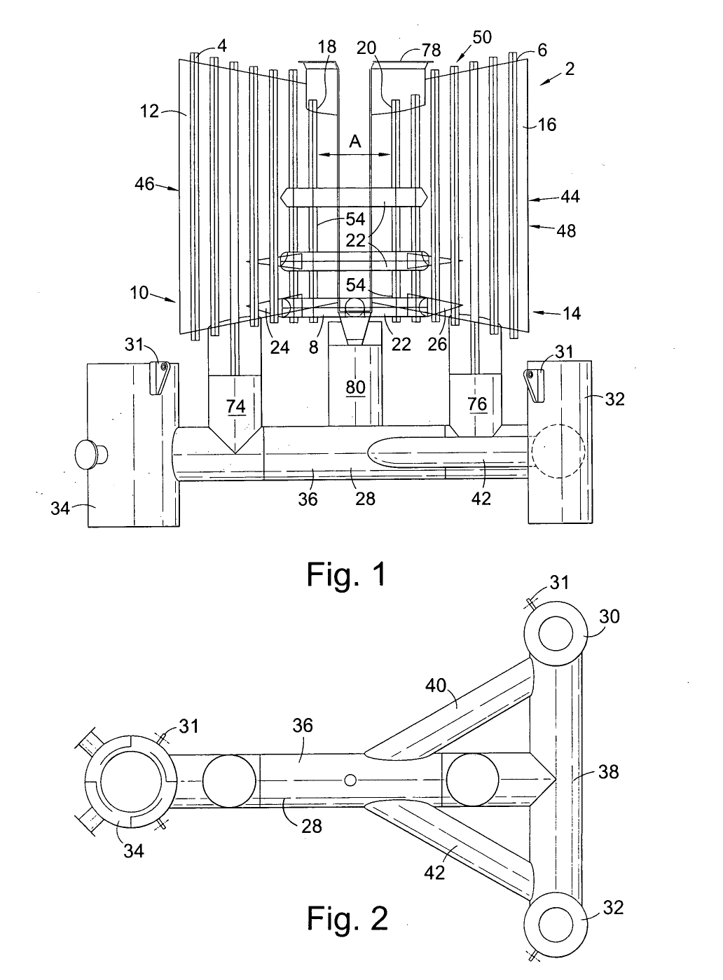

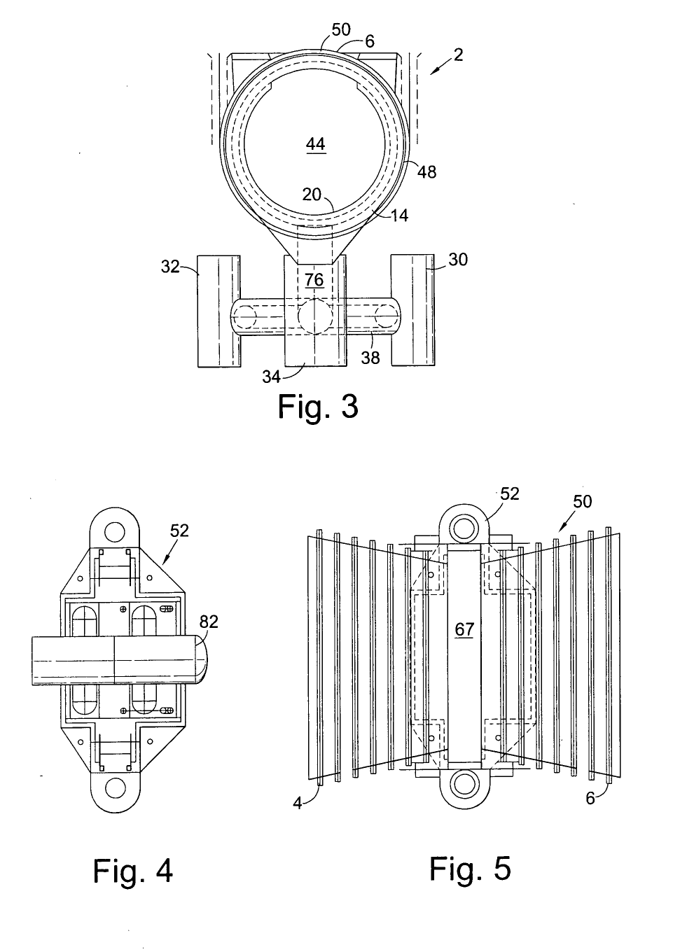

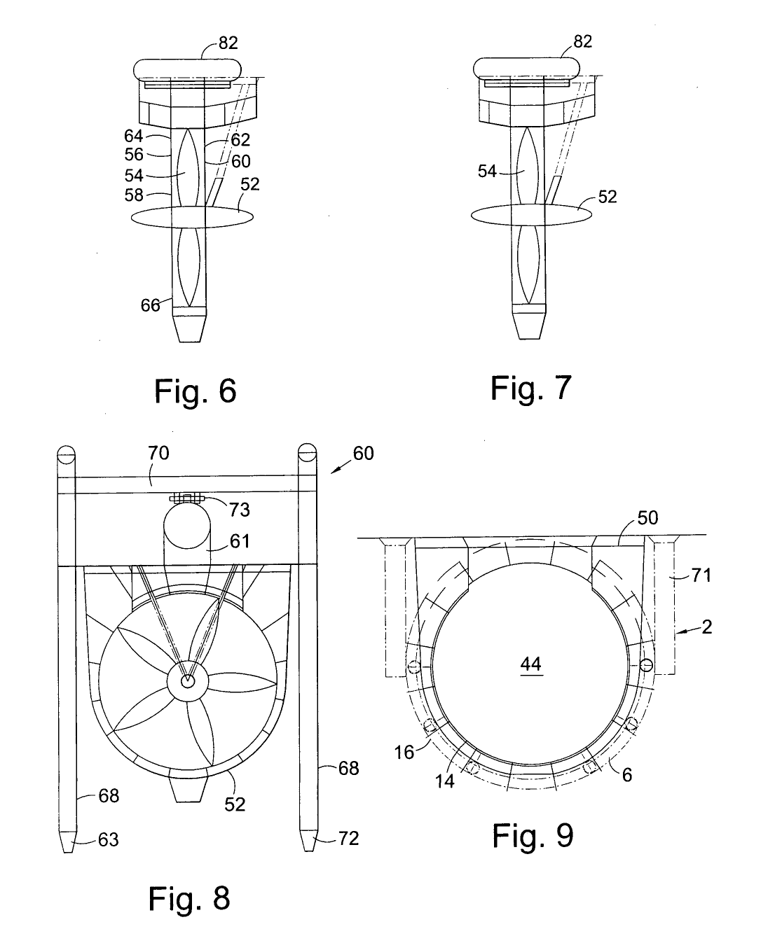

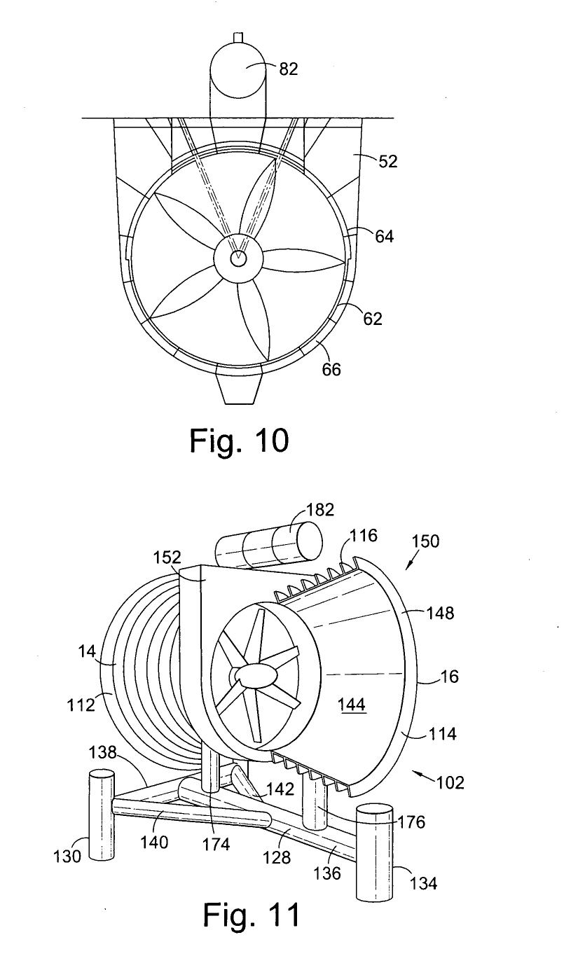

Referring to FIGS. 1 to 10, there is provided an underwater electrical power generator or turbine unit or tidal device, generally designated 2, according to a first embodiment of the present invention and which includes the features hereinbefore described under the heading “Summary of Invention”.

The underwater electrical power generator 2 comprises a first housing part 4, a second housing part 6 and means 8 for connecting the first and second housing parts 4, 6 together. The first housing part 4 comprises an at least partly frusto-conical inner surface 10 and/or comprises an at least partly frusto-conical outer surface 12. The second housing part 6 comprises an at least partly frusto-conical inner surface 14 and/or comprises an at least partly frusto-conical outer surface 16.

Ends 18, 20, i.e. narrower ends of the first and second housing parts 4, 6 are proximally spaced.

The connecting means 8 control or select a spacing between the first and second housing parts 4, 6. The connecting means 8 comprise a plurality of elongate members or bars 22. One end 24 of each bar 22 is attached/attachable, e.g. optionally detachably attached/attachable, to the first housing part 4, and another end 26 of each bar is attached/attachable, e.g. optionally detachably attached/attachable, to the second housing part 6. The ends 24, 26 are flanged. The ends 24, 26 are welded, bolted or otherwise fixed to the respective housing part, e.g. on an outer surface thereof. The bars 22 are akin to launching brackets for ships.

The bars 22 are provided around lower circumferential surfaces of the housing parts 4, 6, the bars 22 being circumferentially spaced from one another. In this embodiment seven bars 22 are provided.

The underwater electrical power generator 2 comprises a base 28, wherein the base 28 comprises three legs 30, 32, 34. This provides a particularly stable arrangement.

There are provided a pair of legs or pillars 30, 32 at one end, and a third leg or pillar 34 at another end. The first and second legs 30, 32 are substantially symmetrically disposed on respective sides of a longitudinal axis of the power generator 2. The third leg 34 is provided upon the longitudinal axis (as viewed from above).

The legs 30, 32, 34 are typically hollow, and include ballast. A volume of the first and second legs 30, 32 is substantially the same. A volume of the third leg 34 is substantially double the volume of either of the first or second legs. That is to say, the volume of the third leg 34 is substantially the same as the combined volume of the first and second legs 30, 32.

A bar (torsion bar) 36 is provided longitudinally extending from the third leg 34 to between the first and second legs 30, 32. A further bar 38 is provided (transversely) between the first and second legs 30, 32, an end of the bar 36 being connected thereto. First and second symmetrically disposed yet further bars 40, 42 are provided between the bar 36 and the further bar 38.

The underwater electrical power generator 2 comprises a flow channel 44 having first and second ends 46,48 and the plurality of legs 30, 32, 34, wherein the legs 30, 32, 34 are provided longitudinally outwardly of the ends 46,48 of the flow channel 44.

This facilitates ease of lifting of the underwater electrical power generator 2 by means of the legs 30, 32, 34. This is because lifting means—such as straps or webs—can be easily placed around the bar/further bar 36, 38 connected to the respective legs 30, 32, 34. Such lifting means associated with each leg 30, 32, 34 allows for three point lifting. Lifting brackets 31 are additionally or alternatively provided for fixing of webs or straps for lifting.

In the disclosed arrangement there are provided the pair of legs 30, 32 outwardly of one end 46 and the third leg 34 outwardly of the other end 48. The pair of legs 30, 32 are provided outwardly of respective lateral or transverse sides of the housing 50 comprising housing parts 4, 6.

The underwater electrical power generator 2 comprises housing 50 and a turbine module 52, wherein the turbine module 52 is removably receivable relative to or within the housing 50, and wherein there are provided sealing means 54 between the housing 50 and the turbine module 52.

The housing 50 comprises first and second housing parts 4, 6. The turbine module 52 is locatable between the first and second housing parts 4, 6. The sealing means 54 typically comprises a polymeric material. The sealing means 54 comprise first sealing means 56 provided between a first end 58 of the module 52 and the first housing part 4. The sealing means 54 comprises second sealing means 60 provided between a second end 62 of the module 52 and the second housing part 6. A first part of the first sealing means 56 are provided on a lower face of a flange 64 provided around at least part of an upper circumferential part of the first end 58 of the module 52. A second part of the first sealing means 56 are provided on a lower face of another flange 66 or part provided around at least part of a lower circumferential part of the first end 58 of the module 52. In use, the second part of the first sealing means 56 abut an upper surface of a flange 67 provided on the housing part 4.

The second sealing means 60 are the same as or similar to the first sealing means 56 but provided on the second end 62 of the module 52.

By this arrangement the device 5 self seals. The weight of the turbine module 52 causes the sealing means 54 to seal between the turbine module 52 and the first and second housing parts 4, 6.

The underwater power generator 2 comprises at least one ground engaging leg 30, 32, 34, wherein at least part of the ground engaging legs 30, 32, 34 comprises a peripherally extending skirt or ground engaging means. The peripherally extending skirt or ground engaging means assists in the at least one leg 30, 32, 34 digging into the ground, e.g. seabed, ocean floor or river bed.

The underwater power generator 2 comprises at least one underwater turbine unit providing housing 50 having flow channel 44 therethrough and at least one turbine means, i.e. module 52, mounted in the flow channel 44 for rotation in response to water flow through the flow channel 44, wherein the turbine unit provides turbine unit part or turbine module 52 releasably mountable in the turbine unit, the turbine unit part or module 52, including at least one of the at least one turbine means 54 and a pump means. The turbine unit part or module 52 is releasably mountable through an aperture or gap in a side wall of the housing 50.

The power generator 2 comprises at least one underwater turbine unit providing housing 50 and at least one turbine means 54, the housing 50 having a liquid flow channel 44 extending therethrough between first and second ends of the housing 50, the flow channel 44 defining a flow restriction comprising a venturi, and the at least one turbine means or module 52 being mountable in the flow channel 44 for rotation along an axis parallel to the flow channel 44, wherein, in use, the housing 50 is stationary and the turbine 54 rotates in response to liquid flow through the flow channel 44, and wherein the housing 50 is provided with a waist 56 on an outermost surface thereof, the waist 56 being narrower than the first and second ends of the housing 50.

The underwater turbine unit or module 52 optionally and beneficially comprises at least one turbine 54, the turbine 54 comprising at least one blade 58, the at least one blade 58 comprising at least one aerofoil which is symmetrical about a mid-chord line thereof.

A docking device 60 for installing and/or removing turbine module 52 from a housing 50 or remainder of an underwater power generator or turbine unit 2 is also provided, as will hereinafter be described in greater detail.

The docking device 59 has means 61 for releasably connecting the docking device 59 to the turbine module 52. The docking device 59 also has means 63 for positioning the docking device 59 relative to the housing 50.

A method of assembling an underwater power generator 2 comprises the steps of:
(a) providing first and second spaced housing parts 4,6;
(b) providing connection means 8 for the first and second housing parts 4, 6;
(c) locating turbine module 52 between the housing parts 4, 6;
(d) longitudinally moving one or both of the housing parts 4, 6 and/or turbine module 52 to suitably locate the housing parts 4, 6 and turbine module 52 relative to one another; and
(e) securing the connection means 8.

In a preferred implementation step (e) is carried out after step (d). However, step (e) can be carried out before step (d). Suitable location allows for removal of the module 52 from the housing parts 4, 6 either on-shore or in situ underwater. Suitable location also allows for sealing means 54 between the module 52 and the first and/or second housing parts 4, 6 to seal.

The module 52 provides an annular member 62, which, optionally with the housing parts 4, 6, form a housing or cowal for a turbine 54 of or in the module. The housing 50 comprises through flow channel 44 within which the turbine 54 is located for rotation around a longitudinal axis of the channel 44.

This invention provides a system for retaining tidal turbines on the seabed and allowing ease of extraction and replacement of the turbine and moving parts for repair and maintenance.

In order to retain tidal devices in situ it is necessary to overcome the sliding, turning and overturning forces exerted on the device by the tidal currents and weather influenced forces. Various methods exist to overcome these forces and retain tidal turbines on the seabed, including the use of piling, anchoring or the use of gravity foundations. Significant technical difficulties and risks are associated with piling and the use of anchors, and therefore the beneficial method according to the invention employs a gravity foundation which requires neither piling or the use of anchors, such as described in the prior art.

Devices to extract energy from tidal currents are by their nature located in areas of high tidal currents, and are subject to high forces which means very large weights are required to keep devices in situ. To avoid recovery of the whole structure to the surface and allow recovery of the turbine and moving parts for repair and maintenance (referred to as the turbine module 52) it is, therefore, preferable that they are held in a separately mounted and extractable unit held within the main structural housing of the tidal device. It is important that sealing integrity between the main structure or housing 50 and the extractable turbine module 52 is achieved during the manufacturing and construction phase and maintained to allow extraction and re-insertion of the turbine module throughout the life of the power generator or tidal device 2. As the tidal device may remain on the seabed for 25 years or more, design to achieve dimensional stability over many years is extremely important.

In order to deploy the turbine module in the tidal device, it is preferable, that the turbine module 52 has a polymeric seal which engages with the housing of tidal device to form a seal. (To allow replacement of the seal it is important that at least part of the seal is attached to the turbine module 52 and not the housing 50).

Movement of the structure of the tidal device will result in the fit between the turbine module 52 and the housing 50 or tidal device either loosening or tightening. A loose fit between the turbine module 52 and the housing 50 will give: (i) poor sealing integrity and therefore loss of performance, and (ii) will result in the turbine module moving in the tidal device 2 with the thrust from the reversing tides. If the fit tightens the turbine module 52 may bind in the tidal device 2 preventing its removal or preventing its re-insertion.

The tidal device 2 of the invention has two separate housing sections or parts 4, 6 (which form two venturi like ducts) that because of their overhung nature would have a tendency to sag over time. To obviate this tendency adjustable stretcher bars or connection means 8 are employed to tie the two housing sections 4, 6 together and provide stiffening and give final adjustment of gap dimensions for the power generator 2.

To further maintain structural stability the housing parts 4, 6 and the turbine module 52 are mounted on a large torque bar 36 suspended by a tripod arrangement which obviates the requirement for seabed preparation. The tripod arrangement consists of three vertical tubes or pillars or legs 30, 32, 34, which may be manufactured from steel and carry ballast, connected by the torque bar 36 and crossbars 38, 40, 42.

The single leg 34 has a cross-sectional area that is equal to the sum of the cross-sectional areas of the two legs 30, 32 at either end of the crossbar 38 in order to maintain equal soil bearing pressure underneath the legs 30, 32, 34 and prevent differential settlement and sagging. In the case of deployment of the tidal device 2 on a sandy or muddy seabed the legs 30, 32, 34 are furnished with so-called “skirts”, e.g. peripherally, which enlarge the surface area and offer resistance to sinkage.

During the installation of the turbine module 52, to prevent damage to the sealing means 54, it is important that the turbine module 52 is accurately installed in the housing 50. To achieve accurate installation a docking device 60 is used to guide the turbine module 52 into the housing 50. The docking device 60 comprises two vertical stabbing 68 pins and a horizontal spreader beam 70 with hydraulically actuated lock or latching means 73 for fixing to the turbine module 52. Attached to the tidal device 2 are “buckets” or hollow tubular means 71 which catch and guide the stabbing pins 68 as the docking device 60 (with turbine module 52) is lowered from a crane onboard a surface vessel (not shown).

As the turbine module 52 is lowered into the tidal device 2, a trapezium shaped docking means 72 located on the bottom of the turbine module 52 engages with a receptacle 71 on the tidal device 2 and secures the turbine module 52 in position. At the same time docking means located at the top of the turbine module engage with pins on the tidal device 2.

When the turbine module 52 has engaged with the tidal device 2, the hydraulic lock means 73 on the docking aid is released, and the docking aid is retrieved to the surface vessel.

To retrieve the turbine module 52 the docking device or aid 60 is lowered into the receiving buckets on the tidal device 2 until it engages with the turbine module 52 and after latching on to the turbine module 52 both are recovered to the surface. Maintenance or replacement of the turbine module 52 is therefore possible.

In this embodiment the first and second housing parts 4,6 are connected to the bar 36 by respective first and second supports 74,76. Between the housing parts 4, 6 is provided a turbine module receiving means 78 and a turbine module support post 80. The turbine module 52 provides a generator module 82.

Referring now to FIG. 11, there is shown a power generator 102 according to a second embodiment of the present invention, like parts being denoted by the same numerals as for the generator 2 of FIG. 1, except incremented by “100”.

The generator 102 differs from the generator 2 in that the generator 102 does not provide a turbine module support post.

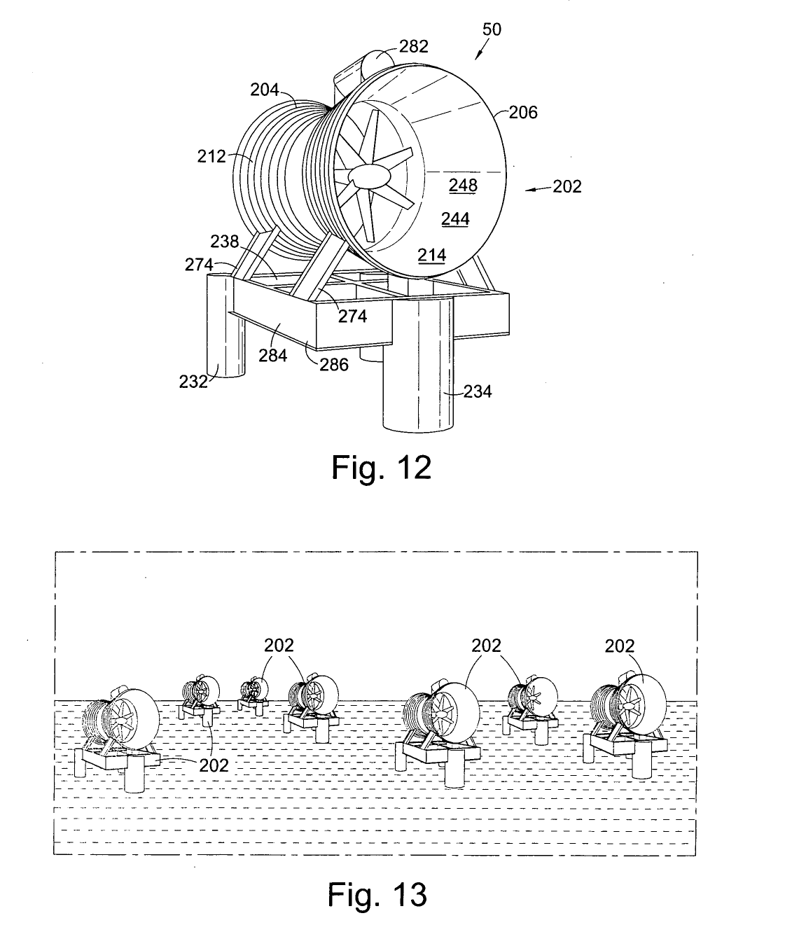

Referring now to FIGS. 12 and 13, there is shown a power generator 202 according to a third embodiment of the present invention, like parts being denoted by the same numerals as for the generator 2 of FIG. 1, except incremented by “200”.

The generator 202 has a rectilinear base 284 with struts 274 extending from the first and second housing parts 4,6 to longitudinal edges 286 of the base 284.

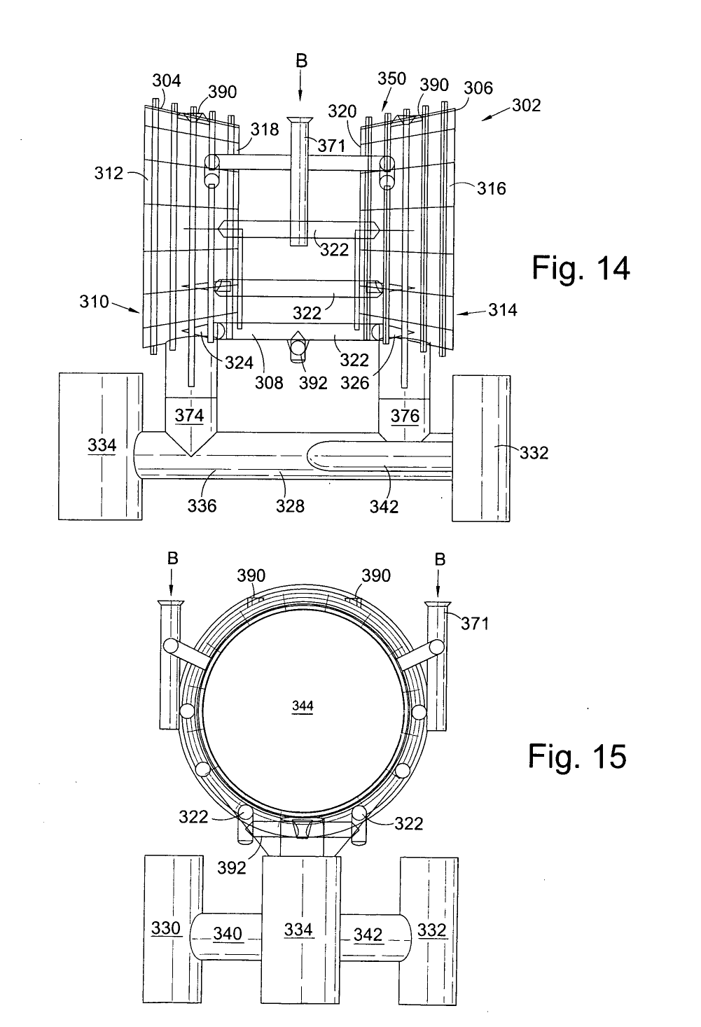

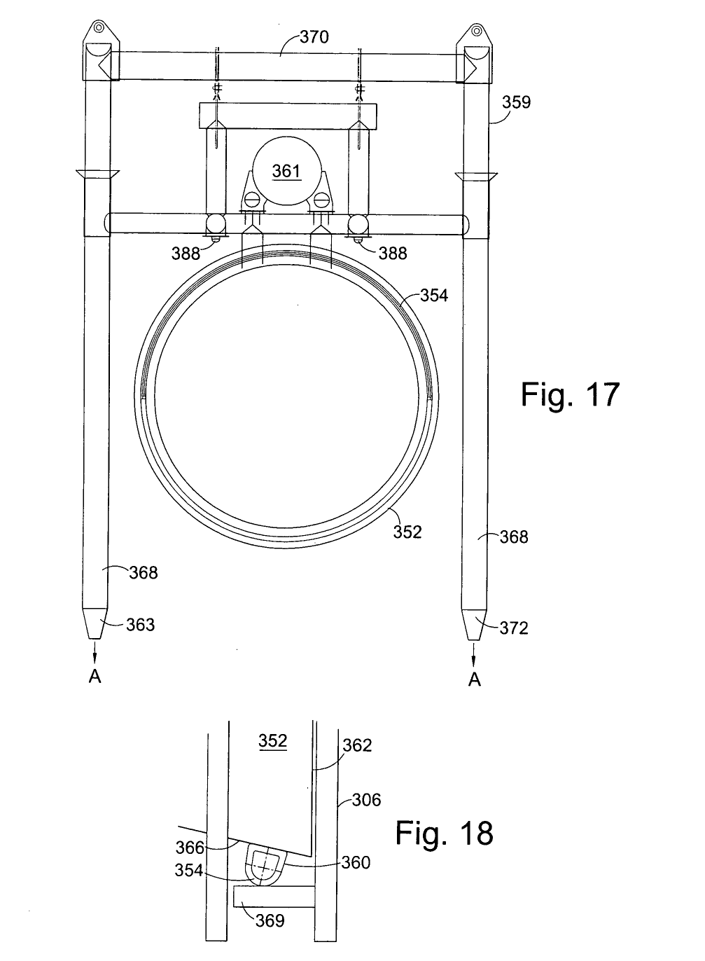

Referring now to FIGS. 14 to 18, there is shown a power generator or turbine unit 302 according to a fourth embodiment of the present invention, like parts being denoted by the same numerals as for generator 2 of FIG. 1, except incremented by “300”.

The underwater power generator 302 comprises a housing 350 and a turbine module 352, wherein the turbine module 352 is removably receivable relative to or within the housing 350, and wherein there are provided sealing means 354 between the housing 350 and the turbine module 352.

The housing 350 comprises first and second housing parts 304,306. The turbine module 352 is locatable between the first and second housing parts 304,306. The sealing means 354 typically comprise a polymeric material. The sealing means 354 comprise first sealing means 356 provided between a first end 358 of the module 352 and the first housing part 304. The sealing means 354 comprise second sealing means 360 provided between a second end 362 of the module 352 and the second housing part 306. The first sealing means 356 are provided on a lower face of a flange 304 provided around at least part of an upper circumferential part of the first end 358 of the module 352. The first sealing means 356 are provided on a lower face of another flange or part 366 provided around at least part of a lower circumferential part of the first end 358 of the module 352. The second sealing means 360 are the same as or similar to the first sealing means 356 but provided on the second end 362 of the module 352.

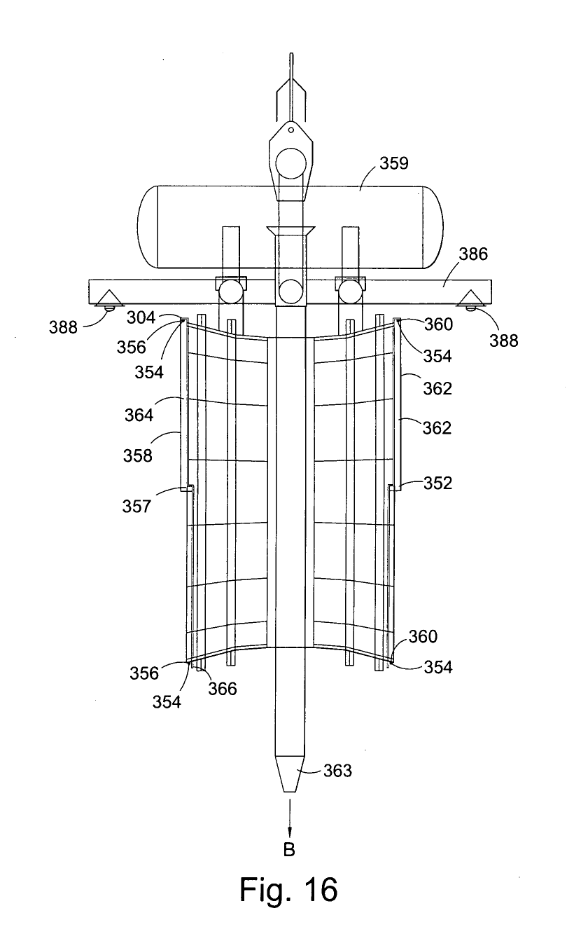

As can be seen from FIG. 16, a first part of the first sealing means 356 provided on a lower face of the flange 364 is longitudinally outward of a second part of the first sealing means 356 provided on lower face of part 366. The first and second parts of the first sealing means 356 are continual or integral with one another, having a kink or L-shaped step at a midpoint 357 adjacent the end of the first housing part 4. The second sealing means 360 are similarly arranged at the opposing end of the second housing part 6.

The turbine module 352 also comprises a support member or yoke 386. The support member 386 comprises pins 388; in this embodiment there are provided four pins 388, two at either end of the support member 386. The pins 388 mate with corresponding recess 390 on the first and second housing parts 304, 306, when the turbine module 353 is lowered into place. The weight of the turbine module 352 is therefore supported by the support member 386 through the first and second housing parts 304, 306. The weight of the turbine module 352 causes the arrangement to seal.

The generator 302 also comprises a transverse bar 392 between the lowermost connecting members 322.

Referring to FIG. 18, the sealing means 354 comprises an endless/closed length of, for example, polymer material. The sealing means 354 is suitably affixed to the turbine module 352. The sealing means 354 is typically hollow to allow such to be squeezed or crushed under load.

To install the turbine module 352, the turbine module 352 is lowered in the substantially vertical direction of arrow ‘B’ such that male parts of the docking device mate with and are received within female parts provided on the housing.

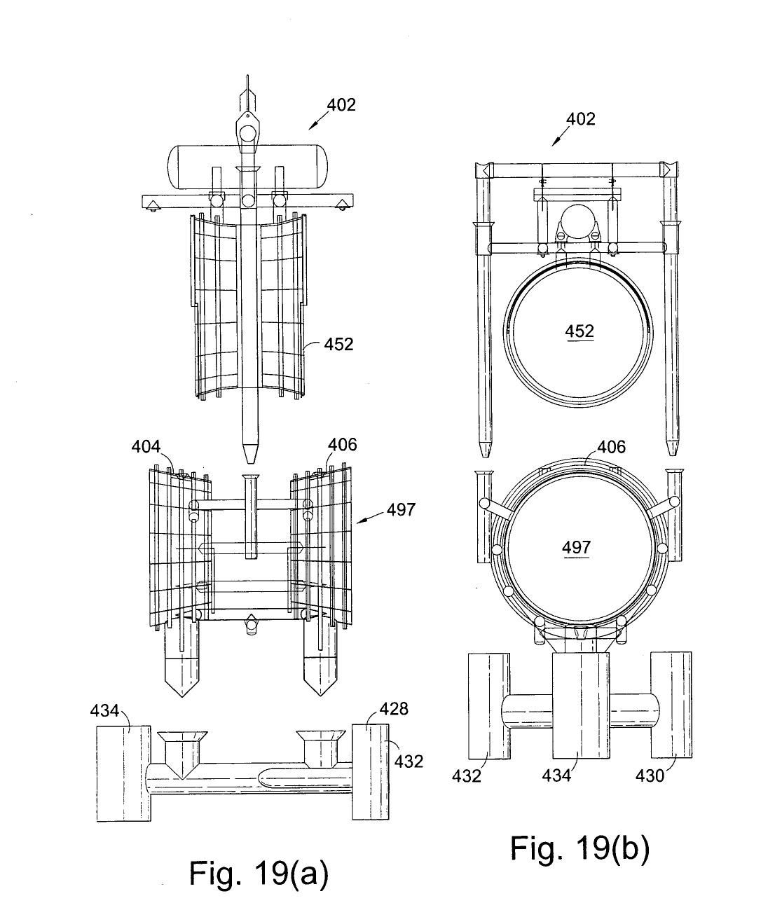

Referring to FIGS. 19(a) and (b), there is shown a power generator 402 according to a fifth embodiment of the present invention, like parts being denoted by like integers, except incremented by “400”.

The generator 402 comprises a base 428 and an assembly comprising the housing parts 404, 406, and turbine module 452.

In use, either on shore or preferably underwater, the base 428 is positioned or the assembly 497 lowered onto the base 428, and secured thereto via co-acting male and female portions 498, 499. This modification is useful where heavy lift vessels are not available or in limited supply. The legs 430, 432, 434 can either be prettied with ballast or filled with ballast after installation.

It will be appreciated that the embodiments of the invention hereinbefore described are given by way of example only, and are not meant to limit the scope thereof in any way.

A generation farm employing power generators according to the invention may have a capacity of 8 MWs—enough to power 5,000 houses.

The present invention may use tidal streams to power turbines of the power generators. Tidal streams are typically relatively fast moving currents created by rising and falling tides.

The disclosed power generator may operate in both ebb and flood tides.

1. An underwater power generator or turbine unit comprising a first housing part, a second housing part and means for connecting and/or spacing the first and second housing parts together.

2. An underwater power generator or turbine unit as claimed in claim 1, wherein the connecting means bridge a gap between the first and second housing parts.

3. An underwater power generator or turbine unit as claimed in claim 1, wherein the first housing part comprises an at least partly frusto-conical inner surface and/or comprises an at least partly frusto-conical outer surface.

4. An underwater power generator or turbine unit as claimed in claim 1, wherein the second housing part comprises an at least partly frusto-conical inner surface and/or comprises an at least partly frusto-conical outer surface.

5. An underwater power generator or turbine unit as claimed in claim 1, wherein narrower ends of the first and second housing parts are proximally spaced from the other.

6. An underwater power generator or turbine unit as claimed in claim 1, wherein the connecting means control or select a spacing between the first and second housing parts.

7. An underwater power generator or turbine unit as claimed in claim 1, wherein the connecting means comprises at least one or a plurality of elongate members or bars.

8. An underwater power generator or turbine unit as claimed in claim 7, wherein one end of the or each bar is attached or attachable, such as detachably attached or attachable, to the first housing part and another end of the or each bar is attached or attachable, such as detachably attached or attachable, to the second housing part.

9. An underwater power generator or turbine unit as claimed in claim 8, wherein the ends are flanged, and the ends are fixed to the respective housing part, such as on an outer surface thereof.

10. An underwater power generator or turbine unit as claimed in claim 7, wherein the bars are provided around lower circumferential surfaces of the housing parts, the bars being optionally circumferentially spaced from one another.

11. An underwater power generator or turbine unit as claimed in claim 1, wherein the underwater power generator or turbine unit comprises a module, such as a turbine module, which is removably receivable within a/the gap or space between the first and second housing parts.

12. An underwater power generator or turbine unit comprising a base, wherein the base comprises three legs.

13. An underwater power generator or turbine unit as claimed in claim 12, wherein there are provided a pair of legs at one end, and a third leg at another end.

14. An underwater power generator or turbine unit as claimed in claim 13, wherein the first and second legs are symmetrically disposed on respective sides of a longitudinal axis of the power generator.

15. An underwater power generator or turbine unit as claimed in claim 14, wherein the third leg is aligned with or provided upon the longitudinal axis.

16. An underwater power generator or turbine unit as claimed in claim 12, wherein the legs are hollow.

17. An underwater power generator or turbine unit as claimed in claim 16, wherein the legs include ballast.

18. An underwater power generator or turbine unit as claimed in claim 16, wherein the volume of the first and second legs is substantially the same.

19. An underwater power generator or turbine unit as claimed in claim 16, wherein a volume of the third leg are substantially double the volume of either of the first or second legs.

20. An underwater power generator or turbine unit as claimed in claim 12, wherein a bar or torsion bar is provided longitudinally extending from the third leg to between the first and second legs.

21. An underwater power generator or turbine unit as claimed in claim 20, a further bar is provided transversely between the first and second legs, an end of the bar being connected thereto.

22. An underwater power generator or turbine unit as claimed in claim 21, wherein first and second symmetrically disposed yet further bars are provided between the bar and the further bar.

23. An underwater power generator or turbine unit comprising a flow channel having first and second ends and a plurality of legs, wherein the legs are provided longitudinally outwardly of ends of flow channel, and/or transversely outwardly of sides of the flow channel.

24. An underwater power generator or turbine unit as claimed in claim 23, wherein there are provided a pair of legs outwardly of one end and a third leg outwardly of the other end.

25. An underwater power generator or turbine unit as claimed in claim 24, wherein the pair of legs are provided outwardly of respective sides of the housing.

26. An underwater power generator or turbine unit comprising a housing and a turbine module, wherein the turbine module is removably receivable relative to or within the housing, and wherein there are provided sealing means between the housing and the turbine module.

27. An underwater power generator or turbine unit as claimed in claim 26, wherein the housing comprises first and second housing parts.

28. An underwater power generator or turbine unit as claimed in claim 27, wherein the turbine module is locatable between the first and second housing parts.

29. An underwater power generator or turbine unit as claimed in claim 26, wherein the sealing means comprises a polymeric material.

30. An underwater power generator or turbine unit as claimed in claim 26, wherein the sealing means comprise first sealing means provided between a first end of the module and the first housing part.

31. An underwater power generator or turbine unit as claimed in claim 30, wherein the sealing means comprise second sealing means provided between a second end of the module and the second housing part.

32. An underwater power generator or turbine unit as claimed in claim 30, wherein the first sealing means are provided on a lower face of a flange provided around at least part of an upper circumferential part of the first end of the module.

33. An underwater power generator or turbine unit as claimed in claim 32, wherein the first sealing means are provided on a lower face of another flange provided around at least part of a lower circumferential part of the first end of the module.

34. An underwater power generator or turbine unit as claimed in claim 31, wherein the second sealing means are provided on a lower face of a portion or flange provided around at least part of a lower circumferential part of the second end of the module.

35. An underwater power generator or turbine unit as claimed in claim 34, wherein the second sealing means are provided on a lower face of another portion or flange provided around at least part of an upper circumferential part of the second end of the module.

36. An underwater power generator or turbine unit comprising at least one ground engaging leg, wherein the ground engaging leg comprises a ground engaging means or peripherally extending skirt.

37. An underwater power generator or turbine unit as claimed in claim 36, wherein the ground engaging means or peripherally extending skirt in use, assists in the at least one leg digging into the ground, such as a seabed, ocean floor or river bed, the ground engaging means optionally comprising a peripherally extending skirt, which is continuous or discontinuous, and optionally the or each leg comprises a hollow tube, which is disposed substantially vertically, in use.

38. An underwater power generator or turbine unit as claimed in claim 1, wherein the power generator comprises at least one underwater turbine unit including a housing having a liquid flow channel therethrough and at least one turbine means mounted in the flow channel for rotation in response to liquid flow through the flow channel.

39. An underwater power generator or turbine unit as claimed in claim 1, wherein the power generator comprises at least one underwater turbine unit providing a housing having a flow channel therethrough and at least one turbine means mounted in the flow channel for rotation in response to water flow through the flow channel, wherein the turbine unit provides a turbine unit part or turbine module releasably mountable in the turbine unit, the turbine unit part including at least one of the at least one turbine means and a pump means.

40. An underwater power generator as claimed in claim 39, wherein the turbine unit part is releasably mountable through an aperture or gap in a side or side wall of the housing.

41. An underwater power generator or turbine unit as claimed in claim 1, wherein the power generator comprises at least one underwater turbine unit providing a housing and at least one turbine means,
the housing having a liquid flow channel extending therethrough between first and second ends of the housing, the flow channel defining a flow restriction comprising a venturi, and
the at least one turbine means being mounted in the flow channel for rotation along an axis parallel to the flow channel, wherein, in use, the housing is stationary and the turbine rotates in response to liquid flow through the flow channel, and wherein
the housing is provided with a waist on an outermost surface thereof, the waist being narrower than the first and second ends of the housing.

42. An underwater power generator or turbine unit as claimed in claim 1, wherein the underwater turbine unit comprises at least one turbine, the turbine comprising at least one blade, the at least one blade comprising at least one aerofoil which is symmetrical about a mid-chord line thereof.

43. A docking device for installing and/or removing a turbine module from a housing or remainder of an underwater power generator or turbine unit.

44. A docking device as claimed in claim 43, wherein the docking device has means for releasably connecting the docking device to the turbine module.

45. A docking device as claimed in claim 43, wherein the docking device has means for positioning the docking device relative to the housing.

46. A docking device as claimed in claim 43, wherein the docking device comprises a hydraulic latch for retaining the turbine module.

47. A docking device as claimed in claim 43, wherein the docking device comprises at least one and optionally two transversely symmetrically disposed male or female portions matable with a respective at least one and preferably two transversely symmetrically disposed female or male portions on the housing.

48. A housing having at least one and preferably two transversely symmetrically disposed female or male portions matable with a docking device having a corresponding at least one and optionally two transversely symmetrically disposed male or female portions.

49. An underwater power generator or turbine unit comprising a housing according to claim 48.

50. A method of assembling an underwater power generator comprising:
(a) providing first and second spaced housing parts;
(b) providing a connection means for the first and second housing parts;
(c) locating a turbine module between the housing parts;
(d) longitudinally moving one or both of the housing parts and/or turbine module to suitably locate the housing parts and turbine module relative to one another; and
(e) securing the connection means.

51. A method as claimed in claim 50, wherein step (e) is carried out after step (d).

52. A method as claimed in claim 50, wherein step (e) is carried out before step (d).

53. A method as claimed in claim 50, wherein the step of locating allows for subsequent removal of the module from the housing parts either on-shore or in situ underwater.

54. A method as claimed in claim 50, wherein the step of locating also allows for sealing means between the module and the first and/or second housing parts to seal.

55. A method as claimed in claim 50, wherein the turbine module provides an annular member, which, optionally with the housing parts, form a housing or cowal for a turbine for in the turbine module.

56. A method as claimed in claim 50, wherein the housing comprises a through flow channel within which the turbine is located for rotation around a longitudinal axis of the channel.

57. A method as claimed in claim 50, wherein the method comprises:
providing a base, either underwater or on shore;
installing an assembly of the housing parts and turbine module onto the base; wherein
optionally the base and assembly are provided with co-acting connection means.

58. An underwater power generator or turbine unit as claimed in claim 1, wherein the generator is an electrical or electricity generator.

59. An underwater power generator or turbine unit as claimed in claim 1.

60. An underwater power generator or turbine unit as hereinbefore described with reference to the accompanying drawings

61-63. (canceled)
